(19) United States
(12) Patent Application Publication
(10) Pub. No.: US 2003/0163337 A1
(43) Pub. Date: Aug. 28, 2003

(54) System and method of rating financial investment

(76) Inventor: Gregory W. Kasten, Nicholasville, KY (US)

Correspondence Address: THOMPSON COBURN, LLP, ONE US BANK PLAZA, SUITE 3500, ST LOUIS, MO, 63101, US

(21) Appl. No.: 10/081,438

(22) Filed: Feb. 22, 2002

(51) Int. Cl. G06F 17/60

(52) U.S. Cl. 705/1

(57) ABSTRACT

A system and method of rating a financial investment in an investment category is disclosed. The method comprises storing financial information about the financial investment and other financial investments in the investment category, and calculating an index for the financial investment based on the financial information such that the index is predictive of the financial investment's future performance. In particular, the financial investment has an expense ratio and a turnover rate, the financial information includes an average expense ratio, and an average turnover rate, and the step of calculating an index comprises comparing the expense ratio to the average expense ratio to generate a compared expense ratio, comparing the turnover rate to the average turnover rate to generate a compared turnover rate, and calculating a percentile ranking for the financial investment for at least one trailing period of time.

### FIELD OF THE INVENTION

The present invention relates to a system and method of rating a financial investment, and in particular to a system and method of calculating an index for the financial investment which is predictive of its future performance.

### BACKGROUND

Today there are more than 13,000 mutual funds for retirement plan investors and individual investors to consider. In addition to mutual funds, investors can choose from several thousand institutional money managers. In the case of retirement plans, the Employment Retirement Income Security Act (ERISA) requires that fiduciaries (i.e. plan sponsors, investment decision makers and anyone acting in a discretionary capacity over a plan) be held to a higher standard than individual investors in selecting investment options. In particular, ERISA requires that a fiduciary act with “the care, skill, prudence, and diligence under the circumstances then prevailing that a prudent man acting in a like capacity and familiar with such matters would use in the conduct of an enterprise of a like character and with like aims . . . . ” In other words, the fiduciary must act not just with prudence, but with the prudence that someone familiar with such matters would exercise.

Not only must fiduciaries implement prudent criteria to make the initial selection of the investment options, the responsible fiduciary must monitor the options to ensure that they continue to be a prudent choice for the plan. Lack of prudent management, lack of ongoing monitoring, and lack of documentation of these activities leaves plan sponsors and fiduciaries exposed to personal liability for employee investment losses as well as insufficient gains. Such liability extends to anyone who possesses or exercises discretion or control over the assets or administration of the plan. Such liability can have huge financial ramifications. To illustrate, retirement plan participants recently sued First Union for, among other claims, underperforming investments in the plan's portfolio. The case was settled for $26,000,000. As a result of this and many similar cases, the financial loss to retirement plan investment fiduciaries is astronomic.

Typically, a plan fiduciary reviews the performance of each fund quarterly, or at least annually, against a comparable index of performance. He or she looks to see if each fund compares favorably to the performance of other funds of the same type and with the same investment objectives. The plan fiduciary often considers how services like Morningstar and Lipper rate the investments at issue. If the comparisons are not favorable or if the ratings are poor, the plan fiduciary will consider switching funds.

The problem all plan fiduciaries face when trying to select or monitor their investments is how to deal with the plethora abundance of information, especially where the information is conflicting. While the rating services are a good tool for assessing an investment's historical performance, they provide no guidance as to the expected future performance of the financial investment.

Another problem is that while some investments may be sound at the time they are selected, they may eventually start to under-perform relative to their peer groups. Since replacements of investments in a plan are disruptive, it is most desirable to keep such replacements to a reasonable and minimum frequency. It is likewise desirable to identify “problem” investments as early on as possible to minimize any losses. Without the ability to predict the future performance of an investment, it is virtually impossible to achieve these objectives except based on pure luck.

There is therefore a need for a system and method of rating a financial investment that allows a fiduciary to improve the predictability of the investment's future performance.

### BRIEF SUMMARY OF THE INVENTION

It is in view of the above problems that the present invention was developed. In particular, a method of rating a financial investment is disclosed which comprises storing financial information about a plurality of financial investments including the financial investment and other financial investments, and calculating an index for the financial investment based on a comparison of the financial information of the financial investment with the financial information of the other financial investments such that the index is predictive of the financial investment's future performance. The financial investment has an expense ratio and a turnover rate, and the financial information includes an average expense ratio and an average turnover rate. The step of calculating the index comprises comparing the expense ratio to the average expense ratio to generate a compared expense ratio, comparing the turnover rate to the average turnover rate to generate a compared turnover rate, and calculating a percentile ranking for the financial investment for at least one trailing period of time. The step of calculating the percentile ranking comprises calculating a one year percentile ranking for the financial investment for the past one year, calculating a three year percentile ranking for the financial investment for the past three years, and calculating a five year percentile ranking for the financial investment for the past five years.

The method may further comprise calculating at least one of a median compared expense ratio, a median compared turnover rate, a median one-year percentile ranking, a median three-year percentile ranking and a median five year percentile ranking in the event at least one of the expense ratio, the turnover rate, the one year percentile rating, the three year percentile ranking and the five year percentile ranking is missing from the financial information.

The step of calculating the index further comprises weighting the compared expense ratio, the compared turnover rate, and the one year, three year and five year percentile rankings, and summing the weighted expense ratio, the weighted turnover rate and the weighted one year, three year and five year percentile rankings. In one embodiment, the compared expense ratio is weighted at 20%, the compared turnover rate is weighted at 5% and the one year, three year and five year percentile rankings are each weighted at 25%.

The method may further comprise comparing the index to a predetermined retention index, and identifying whether the financial investment should be included in or excluded from a financial investment plan based on the comparison. The financial investment may be identified to be excluded from the financial investment plan when the index exceeds the predetermined retention index, and/or included in the financial investment plan when the index does not exceed the pre-determined retention index.

The method may further comprise identifying over time when the financial investment has at least one of the expense ratio which exceeds a maximum expense ratio, the turnover rate which exceeds a maximum turnover rate, the one year percentile ranking which exceeds a maximum one year percentile ranking, the three year percentile ranking which exceeds a maximum three year percentile ranking, and the five year percentile ranking exceeds a maximum five year percentile ranking such that the financial investment is identified to be excluded when at least one of the maximum expense ratio, the maximum turnover rate, the maximum one year percentile ranking, the maximum three year percentile ranking, or the maximum five year percentile ranking has been reached.

A system for rating a financial investment is also disclosed. The system comprises a storage device adapted to store financial information about a plurality of financial investments including the financial investment and other financial investments, and a calculator adapted to calculate an index for the financial investment based on a comparison of the financial information of the financial investment with the financial information of the other financial investments such that the index is predictive of the financial investment's future performance. The financial investment has an expense ratio and a turnover rate, and the financial information includes an average expense ratio, and an average turnover rate. The system further comprises a comparator adapted to compare the expense ratio to the average expense ratio to generate a compared expense ratio and to compare the turnover rate to the average turnover rate to generate a compared turnover rate, and wherein the calculator is further adapted to calculate a percentile ranking for the financial investment for at least one trailing period of time. The calculator is further adapted to calculate a one year percentile ranking for the financial investment for the past one year, a three year percentile ranking for the financial investment for the past three years, and a five year percentile ranking for the financial investment for the past five years.

The calculator may be further adapted to calculate at least one of a median compared expense ratio, a median compared turnover rate, a median one-year percentile ranking, a median three-year percentile ranking and a median five year percentile ranking in the event at least one of the expense ratio, the turnover rate, the one year percentile rating, the three year percentile ranking and the five year percentile ranking is missing from the financial information.

The calculator is further adapted to weight the compared expense ratio, the compared turnover rate, and the one year, three year and five year percentile rankings, and to sum the weighted expense ratio, the weighted turnover rate and the weighted one year, three year and five year percentile rankings. In one embodiment, the compared expense ratio is weighted at 20%, the compared turnover rate is weighted at 5% and the one year, three year and five year percentile rankings are each weighted at 25%.

The comparator may be further adapted to compare the index to a predetermined retention index, and the system may further comprise an identifier being adapted to identify whether the financial investment should be included in or excluded from a financial investment plan based on the comparison. The financial investment may be identified by the identifier to be excluded from the financial investment plan when the comparator determines that the index exceeds the predetermined retention index and/or included in the financial investment plan when the comparator determines that the index does not exceed the pre-determined retention index.

The identifier may be further adapted to identify over time when the financial investment has at least one of the expense ratio which exceeds a maximum expense ratio, the turnover rate which exceeds a maximum turnover rate, the one year percentile ranking which exceeds a maximum one year percentile ranking, the three year percentile ranking which exceeds a maximum three year percentile ranking, and the five year percentile ranking exceeds a maximum five year percentile ranking such that the financial investment is identified to be excluded when at least one of the maximum expense ratio, the maximum turnover rate, the maximum one year percentile ranking, the maximum three year percentile ranking, or the maximum five year percentile ranking has been reached.

### BRIEF DESCRIPTION OF THE SEVERAL VIEWS OF THE DRAWINGS

The accompanying drawings, which are incorporated in and form a part of the specification, illustrate the embodiments of the present invention and together with the description, serve to explain the principles of the invention. In the drawings:

FIG. 1 is a block diagram of a system in accordance with one embodiment of the present invention.

FIG. 2 is a block diagram of a system in accordance with a web-enabled embodiment of the present invention.

FIG. 3 is a flowchart illustrating a method of rating a financial investment in accordance with one embodiment of the present invention using the system of FIG. 1.

FIG. 4 is a flowchart illustrating the step of calculating the index of FIG. 3 in accordance with one embodiment of the present invention.

FIG. 5 is a chart comparing the rating system and method of the present invention to the Morningstar rating service.

### DETAILED DESCRIPTION OF THE INVENTION

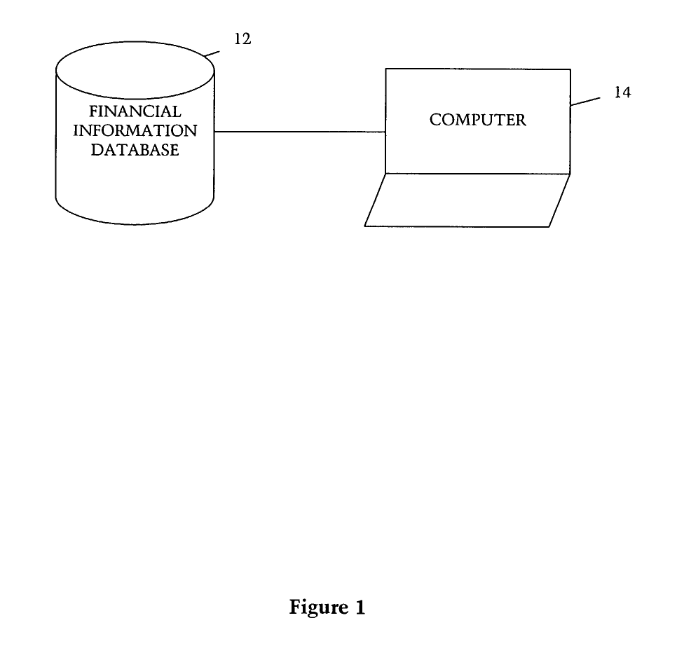

A system and method for rating a financial investment in an investment category is disclosed. While the system and method will be described with respect to rating a financial investment, it can be appreciated by one skilled in the art that the rating applies equally to the fiduciary responsible for managing the financial investment. In one embodiment as shown in FIG. 1, the system 10 includes at least one database 12 for storing financial information about a plurality of financial investments including without limitation what financial investments are in a particular financial investment plan or fund, the fiduciary criteria for each such plan or fund, and what the conditions are for each financial investment. More specifically, it may also include without limitation each financial investment's expense ratio, turnover rate, and its one, three and five year trailing percentile rankings vis-à-vis other financial investments in the same investment category (also known as its positive and negative persistence). While the information is shown in FIG. 1 as being stored in one database, it can be appreciated that the financial information can be stored in a plurality of databases, and that the databases could be commercial databases provided by third parties rather than databases internal to the operator of system 10. Moreover, the term financial investment plan shall be hereinafter used to refer to any financial investment vehicle involving a plurality of financial investments.

A computer 14 includes memory (not shown) for storing a financial database 12, as well the program which is used by the system to rate each financial investment as further described herein. The computer 14 may include communications software to allow it to communicate with third party or external databases. In one embodiment, computer 14 is running Microsoft Access as its database platform, and uses Microsoft Excel as the rating program. It can be appreciated, however, that any database platform such as SQL or a combination of platforms may be used, and that any computer having the necessary processing capabilities and storage capacity may be used.

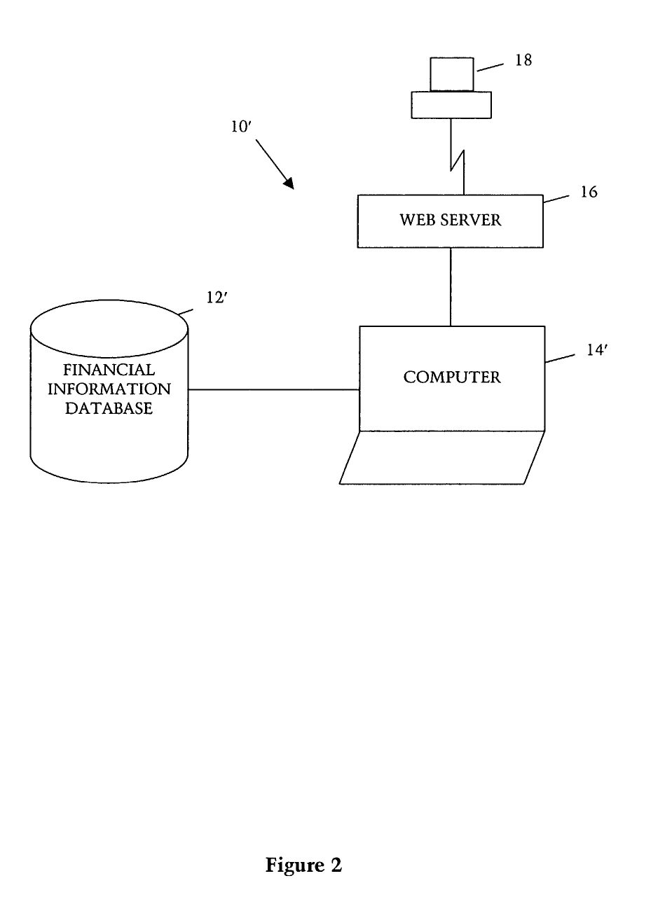

In another embodiment as shown in FIG. 2, the system 10′ is web-enabled. In this embodiment, a web server 16 interfaces computer 14′ to allow users to access system 10′ from a computer 18 having access to the Internet. In one embodiment, computer 14′ and web server 16 are connected by a 100 mbps Ethernet local area network. The financial information database 12′ is copied to web server 16. The connection between computer 14′, user devices 18 and web server 16, however, can be via any communication network such as the telephone network, a satellite network, a cable network or any other communications network capable of transmitting information across it.

Again, computer 14′ may include communication software to allow it to communicate with third party or external databases. Computer 14′ also includes memory (not shown) for storing a program used to rate each financial investment, the steps of which will be further discussed herein. Web server 16 includes communication software to allow users access to the system via the user devices 18. In one embodiment, system 10′ includes a second server (not shown) connected to the web server 16 and running on a SQL database platform which also stores a copy of the financial information stored in the financial information database 12′. With this configuration, the functions performed by system 10 can be separated; the web server 16 focusing on the storage of the web pages to be shown to the users of system 10′, while the SQL server concentrates on the rating calculation (i.e., data storage and number crunching) functions. Such an embodiment provides a more powerful and secure system. It can be appreciated that any type of database 12, computer 14′, web server 16 and user device 18 having the necessary processing capabilities and storage capacity may be used. Moreover, while user devices 18 are shown as personal computers, they can be any type of device that allows a user to access and use the rating program stored on the computer 14′. In a preferred embodiment, two web servers 18 are provided for load balancing and redundancy.

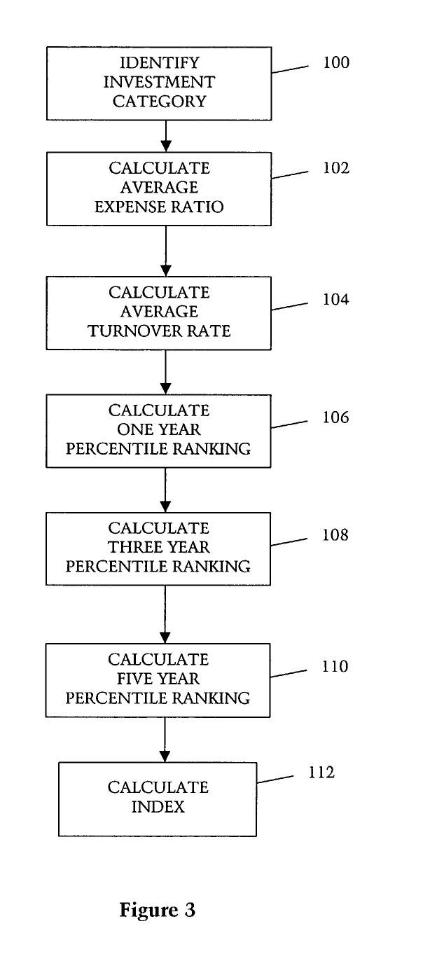

The process of rating a financial investment in accordance with one embodiment of the present invention will now be described with reference to FIG. 3 and a web-based system 10′ being accessed by a plan participant. It can be appreciated, however, that the system need not be web-based to operate, and the user can be anyone with proper access to the system 10. At 100, the system identifies the general investment category for the financial investment at issue. The general investment category could include without limitation a U.S. equity investment category, an international equity investment category, a taxable bond investment category, a U.S. balanced funds investment category, and an index funds investment category. Each of these general investment categories may include subcategories which shall be referred to as peer group categories. For example, the U.S. Equity general investment category could include a large cap growth category, a large cap blend category, a large cap value category, a small cap growth category, a small cap blend category, a small cap value category, a mid-cap growth category, a mid-cap blend category and a mid-cap value category.

At 102, the system calculates the average expense ratio for the other financial investments stored in the financial information database 12 which are in the same investment category as the financial investment at issue. It can be appreciated, however, that the average expense ratio can be alternatively calculated at a peer group category level. This step is performed by obtaining the expense ratios for each such other financial investment, totaling the expense ratios and then dividing the total by the number of the other financial investments from which expense ratios were obtained. In general, the lower average expense ratio the better. Table 1 below shows an example of the results of such a calculation for five different investment categories. Investment Category Number of Funds Average Expense Ratio

TABLE 1

| Investment Category | Number of Funds | Average Expense Ratio |
|---|---|---|
| U.S. Equity | 6145 | 1.43% |
| International Equity | 1736 | 1.86% |
| Taxable Bond | 2152 | 1.11% |
| U.S. Balanced Funds | 744 | 1.28% |
| Index Funds | 285 | 0.67% |

Referring back to FIG. 3, at 104, the system calculates the average turnover rate for the other financial investments in the same investment category as the financial investment at issue. Again, it can be appreciated that the average turnover rate can be calculated at a peer group category level. This step is performed by obtaining the turnover rates for each such other financial investment, totaling the turnover rates and then dividing the total by the number of the financial investments from which the turnover rates were obtained. In general, the lower the turnover rate, the better. Table 2 below shows an example of the results of such a calculation for five different investment categories.

TABLE 2

| | | Average Annual |
|---|---|---|
| Investment Category | Number of Funds | Turnover Rate |
| U.S. Equity | 6145 | 114% |
| International Equity | 1736 | 93% |
| Taxable Bond | 2152 | 139% |
| U.S. Balanced Funds | 744 | 95% |
| Index Funds | 285 | 40% |

Referring back to FIG. 3, at 106, the system 10 calculates the percentile ranking of the financial investment at issue for the past year. This step is performed by comparing the percentile ranking of each fund to its peer group category. For example, in the case of 1000 large cap growth funds, if the investment return of the fund at issue placed 40^{th}, the fund's percentile ranking would be 4%. At 108, the system 10 calculates the percentile ranking of the financial investment at issue vis-à-vis its peer group category for the past three (3) years. This step is performed in the same way as the one (1) year percentile ranking, except it covers a three (3) year trailing period. Likewise, at 110, the system 10 calculates the percentile ranking of the financial investment at issue vis-à-vis its peer group category for the past five (5) years. This step is again performed in the same way as the one (1) and three (3) year percentile rankings, except it covers a five (5) year trailing period.

In some cases, the expense ratio, the turnover rate, the one year percentile ranking, the three year percentile ranking and/or the five year percentile ranking may be missing from the financial information stored in financial database 12. For example, if the financial investment is only two years old, it will not have a three year or five year percentile ranking. In such cases, the system 10′ will calculate a median for the missing information. In the example mentioned above, the system 10 would calculate three year and five year percentile rankings of fifty percent (50%) each.

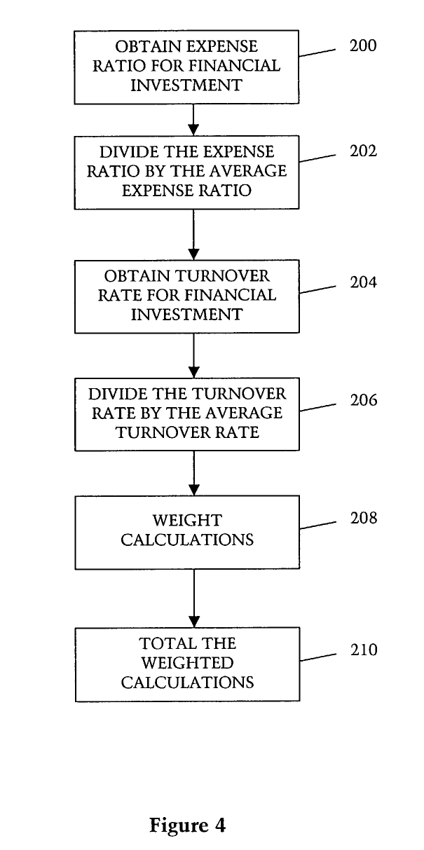

At 112, the system then rates the financial investment at issue by calculating an index therefor. FIG. 4 shows one embodiment of the steps for calculating the index. At 200, the system 10 obtains the expense ratio for the financial investment at issue from the financial information database 12. At 202, the system 10 divides the expense ratio by the average expense ratio calculated in step 102 of FIG. 3. At 204, the system 10 obtains the turnover rate for the financial investment at issue from the financial database 12. At 206, the system 10 divides the turnover rate by the average turnover rate calculated at step 104 in FIG. 3. At 208, weights the results of the calculations of steps 106, 108, and 110 in FIG. 3 at twenty-five percent (25%) each, and the calculations of steps 202 and 206 in FIG. 4 at twenty percent (20%) and five percent (5%), respectively. The steps 200-208 are represented by the following equation:

Fund Expense Ratio÷Investment Category Average Expense Ratio [20% Weight]+Fund Turnover Rate÷Investment Category Average Turnover Rate [5% Weight]+Fund Percentile Ranking For Trailing 1 Year÷100 [25% Weight]+Fund Percentile Ranking For Trailing 3 Years÷100 [25% Weight]+Fund Percentile Ranking For Trailing 5 Years÷100 [25% Weight].

At 210, the system 10 totals the weighted calculations which represents the index for the financial investment at issue. The index is then applied to all financial investments in the financial information database 12 and the financial investments are ranked accordingly, preferably on a percentile basis. For example, if there are 13,000 financial investments, the 130 financial investments having the best index will have a ranking of 1%, the next 130 financial investments will have a ranking of 2% and so on.

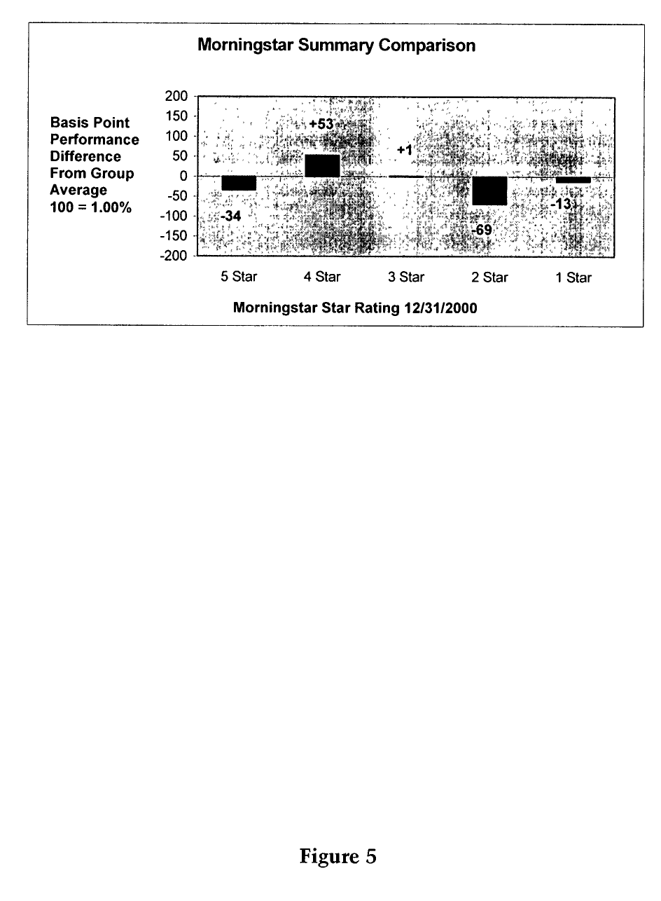

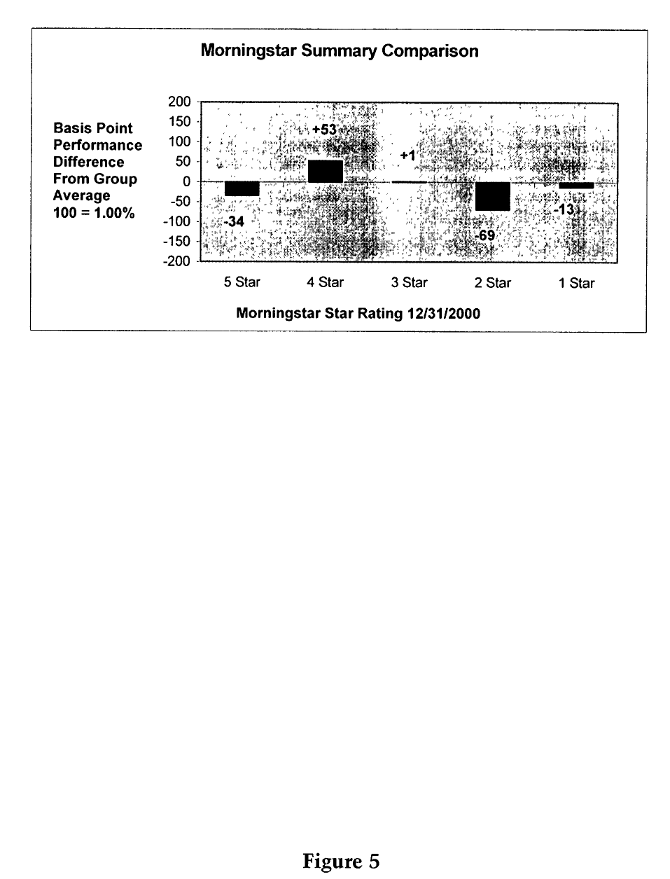

FIG. 5 illustrates the non-predictive nature of rating services like Morningstar. The example shown in FIG. 5 represents a study of the performance of 4401 funds during a nine (9) month period from Jan. 1, 2001 to Sep. 30, 2001 to the Morningstar rating calculated for such funds as of Dec. 31, 2000. As shown, funds having a five (5) star rating under performed the group average by thirty-four (34) basis points, funds having a two (2) star rating under performed the group average by sixty-nine (69) basis points, and the funds with the best rating (i.e. 5 star) did worse than the funds with the worst rating (i.e. 1 star).

Since the index calculated by the system and method of the present invention helps to predict the future performance of a fiduciary or financial investment for which he or she is responsible, it can be used to identify financial investments which are expected to under-perform relative to their peer groups before a significant relative loss occurs. As a result, a pre-determined retention index may be used such that any financial investment having an index exceeding the pre-determined retention index is identified as one to be excluded or replaced in the financial investment plan. The pre-determined retention index may also be used such that any financial investment having an index not exceeding the pre-determined retention index are included or retained in the financial investment plan. It can be appreciated that the pre-determined retention index for the purposes of exclusion or replacement may be different than the one for the purposes of inclusion or retention. In one embodiment, the predetermined retention index is forty (40) with respect to those financial investments which should be rejected and twenty-five (25) with respect to those financial investments which should be included. Of course, any predetermined retention index can be used. Likewise, the predetermined retention index can be set such that financial investments that have an index which is less than it are identified as needing replacement.

In view of the foregoing, it will be seen that the several advantages of the invention are achieved and attained. The embodiments were chosen and described in order to best explain the principles of the invention and its practical application to thereby enable others skilled in the art to best utilize the invention in various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

I claim:

1. A method of rating a financial investment, comprising:
storing financial information about a plurality of financial investments including the financial investment and other financial investments; and
calculating an index for the financial investment based on a comparison of the financial information of the financial investment with the financial information of the other financial investments such that the index is predictive of the financial investment's future performance.

2. The method of claim 1, wherein the financial investment has an expense ratio and a turnover rate, the financial information includes an average expense ratio, and an average turnover rate, and wherein the step of calculating the index comprises:
comparing the expense ratio to the average expense ratio to generate a compared expense ratio;
comparing the turnover rate to the average turnover rate to generate a compared turnover rate; and
calculating a percentile ranking for the financial investment for at least one trailing period of time.

3. The method of claim 2, wherein the step of calculating the percentile ranking comprises:
calculating a one year percentile ranking for the financial investment for the past one year;
calculating a three year percentile ranking for the financial investment for the past three years; and
calculating a five year percentile ranking for the financial investment for the past five years.

4. The method of claim 3, wherein the financial investment has a general investment category and a peer group category within the general investment category, and wherein the average expense ratio is based on the general investment category, the average turnover rate is based on the general investment category, and the one year, three year and five year percentile rankings are based on the peer group category.

5. The method of claim 3, wherein the step of calculating the index further comprises:
weighting the compared expense ratio, the compared turnover rate, and the one year, three year and five year percentile rankings; and
summing the weighted expense ratio, the weighted turnover rate and the weighted one year, three year and five year percentile rankings.

6. The method of claim 5, wherein the compared expense ratio is weighted at 20%, the compared turnover rate is weighted at 5% and the one year, three year and five year percentile rankings are each weighted at 25%.

7. The method of claim 4, wherein the general investment category is one of a U.S. equity category, an international equity category, a taxable bond category, a U.S. balanced fund category and an index fund category.

8. The method of claim 1, further comprising:
comparing the index to a predetermined retention index; and
identifying whether the financial investment should be included in or excluded from a financial investment plan based on the comparison.

9. The method of claim 8, wherein the financial investment is identified to be excluded from the financial investment plan when the index exceeds the predetermined retention index.

10. The method of claim 8, wherein the financial investments is identified to be included in the financial investment plan when the index does not exceed the pre-determined retention index.

11. The method of claim 1, further comprising identifying over time when the financial investment has at least one of the expense ratio which exceeds a maximum expense ratio, the turnover rate which exceeds a maximum turnover rate, the one year percentile ranking which exceeds a maximum one year percentile ranking, the three year percentile ranking which exceeds a maximum three year percentile ranking, and the five year percentile ranking exceeds a maximum five year percentile ranking such that the financial investment is identified to be excluded when at least one of the maximum expense ratio, the maximum turnover rate, the maximum one year percentile ranking, the maximum three year percentile ranking, or the maximum five year percentile ranking has been reached.

12. The method of claim 3, further comprising calculating at least one of a median compared expense ratio, a median compared turnover rate, a median one-year percentile ranking, a median three-year percentile ranking and a median five year percentile ranking in the event at least one of the expense ratio, the turnover rate, the one year percentile rating, the three year percentile ranking and the five year percentile ranking is missing from the financial information.

13. A system for rating a financial investment, comprising:
a storage device adapted to store financial information about a plurality of financial investments including the financial investment and other financial investments; and
a calculator adapted to calculate an index for the financial investment based on a comparison of the financial information of the financial investment with the financial information of the other financial investments such that the index is predictive of the financial investment's future performance.

14. The system of claim 13, wherein the financial investment has an expense ratio and a turnover rate, and the financial information includes an average expense ratio, and an average turnover rate, and wherein the system further comprises a comparator adapted to compare the expense ratio to the average expense ratio to generate a compared expense ratio and to compare the turnover rate to the average turnover rate to generate a compared turnover rate, and wherein the calculator is further adapted to calculate a percentile ranking for the financial investment for at least one trailing period of time.

15. The system of claim 14, wherein the calculator is further adapted to calculate a one year percentile ranking for the financial investment for the past one year, a three year percentile ranking for the financial investment for the past three years, and a five year percentile ranking for the financial investment for the past five years.

16. The system of claim 15, wherein the financial investment has a general investment category and a peer group category within the general investment category, and wherein the average expense ratio is based on the general investment category, the average turnover rate is based on the general investment category and the one year, three year and five year percentile rankings are based on the peer group category.

17. The system of claim 15, wherein the calculator is further adapted to weight the compared expense ratio, the compared turnover rate, and the one year, three year and five year percentile rankings, and to sum the weighted expense ratio, the weighted turnover rate and the weighted one year, three year and five year percentile rankings.

18. The system of claim 17, wherein the compared expense ratio is weighted at 20%, the compared turnover rate is weighted at 5% and the one year, three year and five year percentile rankings are each weighted at 25%.

19. The system of claim 16, wherein the general investment category is one of a U.S. equity category, an international equity category, a taxable bond category, a U.S. balanced fund category and an index fund category.

20. The system of claim 13, wherein the comparator is further adapted to compare the index to a predetermined retention index, and wherein the system further comprises an identifier being adapted to identify whether the financial investment should be included in or excluded from a financial investment plan based on the comparison.

21. The system of claim 20, wherein the financial investment is identified by the identifier to be excluded from the financial investment plan when the comparator determines that the index exceeds the predetermined retention index.

22. The system of claim 21, wherein the financial investment is identified by the identifier to be included in the financial investment plan when the comparator determines that the index does not exceed the predetermined retention index.

23. The system of claim 13, wherein the identifier is further adapted to identify over time when the financial investment has at least one of the expense ratio which exceeds a maximum expense ratio, the turnover rate which exceeds a maximum turnover rate, the one year percentile ranking which exceeds a maximum one year percentile ranking, the three year percentile ranking which exceeds a maximum three year percentile ranking, and the five year percentile ranking exceeds a maximum five year percentile ranking such that the financial investment is identified to be excluded when at least one of the maximum expense ratio, the maximum turnover rate, the maximum one year percentile ranking, the maximum three year percentile ranking, or the maximum five year percentile ranking has been reached.

24. The system of claim 15, wherein the calculator is further adapted to calculate at least one of a median compared expense ratio, a median compared turnover rate, a median one-year percentile ranking, a median three-year percentile ranking and a median five year percentile ranking in the event at least one of the expense ratio, the turnover rate, the one year percentile rating, the three year percentile ranking and the five year percentile ranking is missing from the financial information.
